(19) United States
(12) Patent Application Publication
(10) Pub. No.: US 2022/0295786 A1
(43) Pub. Date: Sep. 22, 2022

(54) BUOYANT ARTICLES COMPRISING LARVICIDES AND METHODS OF USING THE SAME

(71) Applicant: Fernando Thome Kreutz, Porto Alegre RS (BR)

(72) Inventor: Fernando Thome Kreutz, Porto Alegre RS (BR)

(21) Appl. No.: 17/637,220

(22) PCT Filed: Aug. 21, 2020
(86) PCT No.: PCT/IB2020/057879

§ 371 Date: Feb. 22, 2022

Related U.S. Application Data
(60) Provisional application No. 62/890,913, filed on Aug. 23, 2019.

(51) Int. Cl. A01N 25/08; A01N 25/34; A01N 63/23; C02F 1/50

(52) U.S. Cl. CPC A01N 25/08; A01N 25/34; A01N 63/23; C02F 1/50; C02F 2103/007

(57) ABSTRACT

A buoyant article is provided. The buoyant larvicidal article comprises a silicate, a larvicide associated with the silicate, and a binder. The binder is for agglomerating the silicate. In additional or alternative aspects, the buoyant larvicidal article comprises a buoyant moiety, a larvicide associated with the buoyant moiety, and a binder for agglomerating the buoyant moiety. Methods of making the buoyant article and uses thereof are also provided.

### FIELD

The present disclosure relates to larvicides. In particular, the present disclosure relates to buoyant articles comprising larvicides, as well as related methods.

### BACKGROUND

Mosquito-borne diseases, such as Dengue and Zika virus, are major public health concerns. Methods of controlling the spread of these diseases, and/or their initiation by preventing the development of mosquitos from larvae have been investigated.

For example, U.S. Pat. No. 4,631,857 describes a molded non-layered unitary article (serving as a larvicide carrier) that is formed solely from a substantially homogeneous mixture consisting of cork particles and a molding-type of plaster into which a larvicidal microorganism, such as Bti, has been added. The article may be dispensed conveniently, on to either small or large bodies of water, without regard for its orientation relative to the body of water. The article has a specific gravity of less than 1.0 and floats freely on the surface of the water, but if desired, may have a restrained-floating application.

Brazilian Patent Application No. 102014018333 describes the development and use of a floating vermiculite mineral as an adsorbent matrix of larvicidal microorganisms for application in water deposit sites and in watercourses (ponds and streams) in the biological control of disease-carrying mosquitos.

### SUMMARY

In accordance with an aspect, there is provided a buoyant larvicidal article comprising:

a silicate;

a larvicide associated with the silicate; and

a binder for agglomerating the silicate.

In an aspect, the silicate is buoyant.

In an aspect, the silicate is expandable.

In an aspect, the silicate is a hydrous silicate.

In an aspect, the silicate is expandable to a volume of about 0.5 times to about 20 times an original volume of the silicate.

In an aspect, the silicate is used in an amount of about 5% w/w to about 75% w/w.

In an aspect, the silicate is used in an amount of about 32% w/w.

In an aspect, the silicate comprises a silicate mineral.

In an aspect, the silicate mineral is selected from the group consisting of nesosilicates, sorocilicates, cyclosilicates, inosilicates, phyllosilicates, tectosilicates and combinations thereof.

In an aspect, the silicate mineral comprises a phyllosilicate.

In an aspect, the phyllosilicate comprises a clay mineral.

In an aspect, the clay mineral is selected from the group consisting of halloysite, kaolinite, illite, dickite, nacrite, nontronite, beidellite, smectite, montmorillonite, vermiculite, talc, sepiolite, palygorskite, pyrophyllite and combinations thereof.

In an aspect, the clay mineral comprises vermiculite.

In an aspect, the larvicide is selected from the group consisting of a microorganism, a chemical agent, a botanical oil, and combinations thereof.

In an aspect, the larvicide is used in an amount of about 0.01% to about 20% w/w. In an aspect, the larvicide is used in an amount of about 1.2% w/w.

In an aspect, the microorganism is selected from Bacillus sphaericus (Bs), Bacillus thuringiensis (Bt), Bt fermentate, aquatic fungi and combinations thereof.

In an aspect, the Bacillus thuringiensis (Bt) subspecies is selected from the group consisting of aizawai, alesti, berliner, cameroun, canadiensis, colmeri, coreanensis, dakota, darmstadiensis, dendrolimus, entomocidus, finitimus, fukuokaensis, galleriae, higo, Indiana, israelensis, japonensis, japonensis buibui, jegathesan, kenyae, kumamotoensis, kunthala, kurstaki, kyushuensis, medellin, mexcanensis, morrisoni, nigeriae, neoleonensis, ongbei, ostriniae, Pakistani, pondicheriensis, roskildiensis, san diego, shandogiensis, shanghai, silo, sotto, subtoxicus, tenebrionis, thompsoni, thuringiensis, tochigiensis, tohokuensis, tolworthi, toumanoffi, yunnanensis, wuhanensis, and combinations thereof.

In an aspect, the Bt subspecies comprises israelensis.

In an aspect, the chemical agent is selected from the group consisting of S-Hydroprene, S-Kinoprene, Methoprene, S-Methoprene, organophosphates, chlorinated hydrocarbons and combinations thereof.

In an aspect, the organophosphate is selected from the group consisting of temephos, echothiophate, diisopropyl fluorophosphate, tabun, tabun, sarin, soman, cyclosarin, diazinon, malathion, parathion and combinations thereof.

In an aspect, the botanical oil is neem oil.

In an aspect, the binder is buoyant.

In an aspect, the binder is biodegradable.

In an aspect, the binder is used in an amount of about 5% to about 95% w/w.

In an aspect, the binder and the silicate act synergistically to provide buoyancy to the article.

In an aspect, the binder comprises a polymer.

In an aspect, the polymer comprises a cross-linked polymer or a linear polymer.

In an aspect, the polymer comprises a viscoelastic polymer.

In an aspect, the polymer comprises polyvinyl alcohol.

In an aspect, the polymer comprises a borate ion.

In an aspect, the polymer comprises polyvinyl alcohol and a borate ion.

In an aspect, the polymer comprises a silicone polymer.

In an aspect, the silicone polymer is selected from the group consisting of siloxane gums, silicone elastomers, polysiloxanes, crosslinked siloxane polymers and combinations thereof.

In an aspect, the polymer comprises a polysaccharide selected from the group consisting of galactomannan, guar gum, starch and combinations thereof.

In an aspect, the starch is derived from corn, wheat, potato, cassava, yam, peas or lentils.

In an aspect, wherein the binder is not a sulfate mineral.

In an aspect, the binder is not gypsum.

In an aspect, the binder comprises slime.

In an aspect, the article is a unit dose form.

In an aspect, the unit dose form is ready to use.

In an aspect, the unit dose form is a dried solid.

In an aspect, the unit dose form has an amount of the larvicide that is based on surface area of a liquid and/or volume of the liquid.

In an aspect, the unit dose form has an amount of the larvicide that is based on surface area of a liquid.

In an aspect, the unit dose form has an amount of the larvicide that is not based on volume of a liquid.

In an aspect, the article, when placed in a liquid, disintegrates over time dispersing the larvicide over a surface of the liquid.

In an aspect, greater than 50% of the larvicide present in the article remains at the surface of the liquid for greater than 24 hours.

In an aspect, greater than 60% of the larvicide present in the article remains at the surface of the liquid for greater than 24 hours.

In an aspect, greater than 70% of the larvicide present in the article remains at the surface of the liquid for greater than 24 hours.

In an aspect, greater than 80% of the larvicide present in the article remains at the surface of the liquid for greater than 24 hours.

In an aspect, greater than 90% of the larvicide present in the article remains at the surface of the liquid for greater than 24 hours.

In an aspect, the article remains buoyant for about 24 hours to about 168 hours.

In an aspect, the liquid is a slow-moving or stagnant liquid.

In an aspect, the liquid is a reservoir, catch basin, potable water storage tank, a pond, a lake, a swamp, a marsh, or a culvert.

In an aspect, the article has a specific gravity of less than about one.

In an aspect, the article has a substantially round shape.

In an aspect, the article has a sheet-like shape that is sectionable into a plurality of unit dose forms.

In accordance with an aspect, there is provided a buoyant larvicidal article comprising:
a buoyant moiety;
a larvicide associated with the buoyant moiety; and
a binder for agglomerating the buoyant moiety.

In an aspect, the buoyant moiety comprises an aquatic plant or part thereof.

In an aspect, the buoyant moiety comprises a corn cob or part thereof and/or wherein the buoyant moiety comprises dry plant material.

In an aspect, the article further comprises a silicate.

In an aspect, there is provided a method of reducing mosquito populations and/or reducing the spread of mosquito-borne disease, the method comprising placing the article as described herein in the liquid.

In an aspect there is provided a method of treating a liquid having an unknown volume, comprising placing the article as described herein in the liquid.

In an aspect, the method further comprises allowing the article as defined in any one of claims 1 to 45 to disintegrate over time.

In an aspect, the method further comprises allowing the larvicide to remain at a surface of the liquid for greater than 24 hours.

In accordance with an aspect, there is provided a use of the article described herein for reducing mosquito populations and/or reducing the spread of mosquito-borne disease.

In accordance with an aspect, there is provided a use of the article described herein for treating a liquid having an unknown volume.

In accordance with an aspect, there is provided a method of making a buoyant article, the method comprising

associating a silicate with a larvicide; and

agglomerating the silicate with a binder.

In an aspect, the silicate is buoyant.

In an aspect, the silicate is a hydrous silicate.

In an aspect, the silicate is used in an amount of about 5% to about 75% w/w.

In an aspect, the silicate is used in an amount of about 32% w/w.

In an aspect, the silicate is an expanded silicate.

In an aspect, the expanded silicate is expanded to a volume of about 0.5 times to about 20 times an original volume of the silicate by heating.

In an aspect, the expanded silicate comprises a silicate mineral.

In an aspect, the silicate mineral is selected from the group consisting of nesosilicates, sorocilicates, cyclosilicates, inosilicates, phyllosilicates, tectosilicates and combinations thereof.

In an aspect, the silicate mineral comprises a phyllosilicate.

In an aspect, the phyllosilicate comprises a clay mineral.

In an aspect, the clay mineral is selected from the group consisting of halloysite, kaolinite, illite, dickite, nacrite, nontronite, beidellite, smectite, montmorillonite, vermiculite, talc, sepiolite, palygorskite, pyrophyllite and combinations thereof.

In an aspect, the clay mineral comprises vermiculite.

In an aspect, the larvicide is selected from the group consisting of a microorganism, a chemical agent, a botanical oil, and combinations thereof.

In an aspect, the larvicide is used in an amount of about 0.01% to about 20% w/w.

In an aspect, the larvicide is used in an amount of about 1.2% w/w.

In an aspect, the microorganism is selected from Bacillus sphaericus (Bs), Bacillus thuringiensis (Bt), Bt fermentate, aquatic fungi and combinations thereof.

In an aspect, the Bacillus thuringiensis (Bt) subspecies is selected from the group consisting of aizawai, alesti, berliner, cameroun, canadiensis, colmeri, coreanensis, dakota, darmstadiensis, dendrolimus, entomocidus, finitimus, fukuokaensis, galleriae, higo, Indiana, israelensis, japonensis, japonensis buibui, jegathesan, kenyae, kumamotoensis, kunthala, kurstaki, kyushuensis, medellin, mexcanensis, morrisoni, nigeriae, neoleonensis, ongbei, ostriniae, Pakistani, pondicheriensis, roskildiensis, san diego, shandogiensis, shanghai, silo, sotto, subtoxicus, tenebrionis, thompsoni, thuringiensis, tochigiensis, tohokuensis, tolworthi, toumanoffi, yunnanensis, wuhanensis, and combinations thereof.

In an aspect, the Bt subspecies comprises israelensis.

In an aspect, the chemical agent is selected from the group consisting of S-Hydroprene, S-Kinoprene, Methoprene, S-Methoprene, organophosphates, chlorinated hydrocarbons and combinations thereof.

In an aspect, the organophosphate is selected from the group consisting of temephos, echothiophate, diisopropyl fluorophosphate, tabun, tabun, sarin, soman, cyclosarin, diazinon, malathion, parathion and combinations thereof.

In an aspect, the botanical oil is neem oil.

In an aspect, the binder is buoyant.

In an aspect, the binder is biodegradable.

In an aspect, the binder is used in an amount of about 5% to about 95% w/w.

In an aspect, the binder and the silicate act synergistically to provide buoyancy to the article.

In an aspect, the binder comprises a polymer.

In an aspect, the polymer comprises a cross-linked polymer or a linear polymer.

In an aspect, In an aspect, the polymer comprises a viscoelastic polymer.

In an aspect, the polymer comprises polyvinyl alcohol.

In an aspect, the polymer comprises a borate ion.

In an aspect, the polymer comprises polyvinyl alcohol and a borate ion.

In an aspect, the polymer comprises a silicone polymer.

In an aspect, the silicone polymer is selected from the group consisting of siloxane gums, silicone elastomers, polysiloxanes, crosslinked siloxane polymers and combinations thereof.

In an aspect, the polymer comprises a polysaccharide selected from the group consisting of galactomannan, guar gum, starch and combinations thereof.

In an aspect, the starch is derived from corn, wheat, potato, cassava, yam, peas or lentils.

In an aspect, the binder is not a sulfate mineral.

In an aspect, the binder is not gypsum.

In an aspect, the binder comprises slime.

In an aspect, the associating comprising mixing a lower alkyl alcohol with the silicate and the larvicide.

In an aspect, the lower alkyl alcohol is selected from ethylene glycol, propylene glycol, or glycerol.

In an aspect, the method further comprises drying the agglomerated article in an incubator for about 3 days at about 37° C.

In an aspect, the agglomerated article is a unit dose form.

In an aspect, the unit dose form is ready to use.

In an aspect, the unit dose form is a dried solid.

In an aspect, the unit dose form has a substantially round shape.

In an aspect, the unit dose form has a sheet-like shape that is sectionable into a plurality of unit dose forms.

In accordance with an aspect, there is provide a buoyant article obtained by the method described herein.

The novel features of the present invention will become apparent to those of skill in the art upon examination of the following detailed description of the invention. It should be understood, however, that the detailed description of the invention and the specific examples presented, while indicating certain aspects of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The present invention will be further understood from the following description with reference to the Figures, in which:

FIG. 1 shows an embodiment of the article described herein as a substantially round unit dose form;

FIG. 2 shows the article of FIG. 1 floating on a surface of a liquid; and

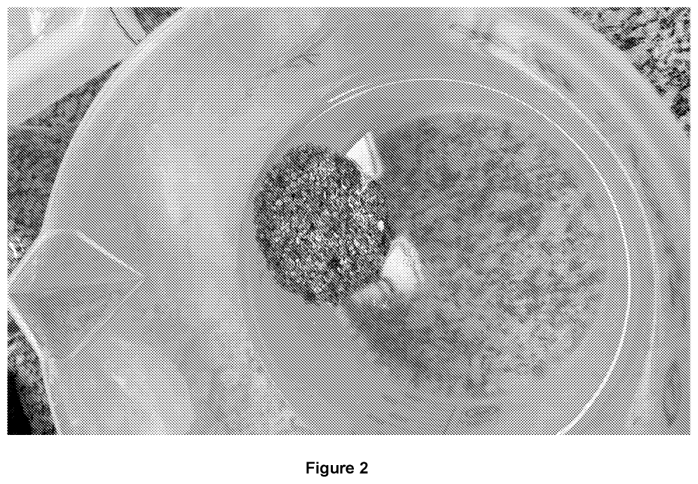

FIG. 3 shows another embodiment of the article described herein as a sheet-like article, cut into a plurality of substantially square unit dose forms.

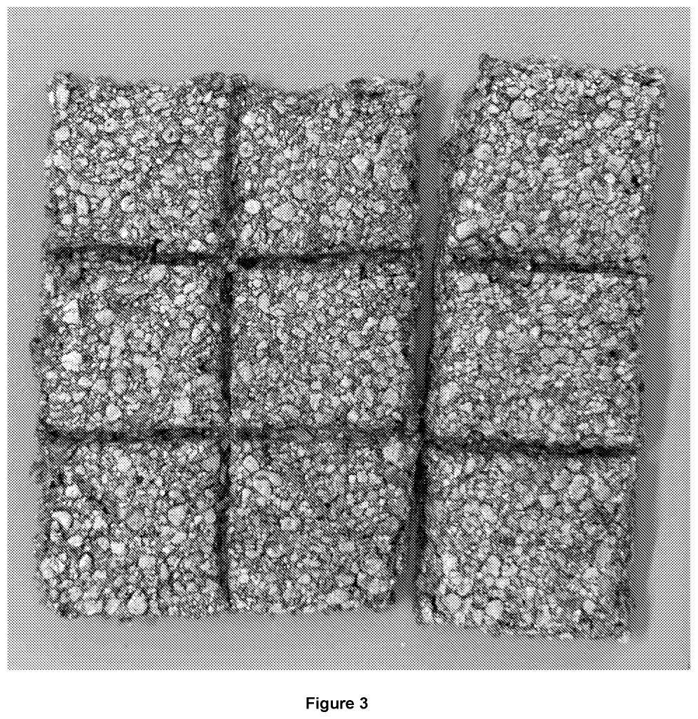

### DETAILED DESCRIPTION

### Definitions

Unless otherwise explained, all technical and scientific terms used herein have the same meaning as commonly understood by one of ordinary skill in the art to which this disclosure belongs. Although any methods and materials similar or equivalent to those described herein are contemplated for use in the articles, compositions, and methods, the typical materials and methods are described herein. In describing and claiming the present invention, the following terminology will be used.

As used herein, the term “silicate” is used to mean silicate minerals, ionic solids with silicate anions, as well as rock types that consist predominantly of such minerals. In that context, the term also includes non-ionic compounds such as silicon dioxide SiO2 (e.g. silica, quartz). The term may also include minerals where aluminum or other tetravalent atoms replace some of the silicon atoms, as in the aluminosilicates.

The term “organophosphate” as used herein, pertains to compounds that are generally esters, amides, or thiol derivatives of phosphoric, phosphonic, or phosphinic acids.

The term “expandable” means that the component having this property (e.g. the silicate) is capable of increasing its size/volume when subjected to a type of stress (e.g. heating). For example, in respect of vermiculite, when heated, vermiculite expands or exfoliates to an increased size/volume (which may or may not be associated with changes in other physical/chemical properties, such as, for example, colour, shape, and/or density of the vermiculite).

The term “buoyant” or “buoyancy” means to float on the top of a liquid (e.g. water), or to float at or near the surface of the liquid. Typically, for an object to be buoyant, the specific gravity of that object is less than about one.

The term “hydrous” means that the component, for example, the silicate, is hydrated (e.g. containing water, especially water of crystallization or hydration).

When introducing elements disclosed herein, the articles “a”, “an”, “the”, and “said” are intended to mean that there may be one or more of the elements.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having,” and their derivatives. It will be understood that any embodiments described as “comprising” certain components may also “consist of” or “consist essentially of,” those components wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known acceptable additive, excipient, diluent, carrier, and the like, suitable for use in the buoyant article described herein. Typically, a composition consisting essentially of a set of components will comprise less than 5% by weight, typically less than 3% by weight, and more typically less than 1% by weight of non-specified components.

It will be understood that any component defined herein as being included may be explicitly excluded from the claimed invention by way of proviso or negative limitation, such as any specific compounds or method steps, whether implicitly or explicitly defined herein. For example, as described herein, the binder is not a sulfate mineral, such as, for example, gypsum.

In addition, all ranges given herein include the end points of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

### Buoyant Articles

Buoyant articles are described herein. In general, the buoyant article comprises a silicate, a larvicide associated with the silicate, and a binder for agglomerating the silicate.

In typical aspects, the silicate is buoyant, hydrous, and/or expandable. In this way, the silicate itself provides buoyancy to the article or may assist in the buoyancy of the article. In additional or alternative aspects, the silicate may expand or increase its volume when subjected to heating at high temperatures. For example, the increase in volume is typically an increase in volume by about 0.1 to about 20 times from its original volume, such as from about 0.1 times, about 0.2 times, about 0.5 times, about 0.7 times, about 1 time, about 1.5 times, about 2 times, about 3 times, about 4 times, about 5 times, about 6 times, about 7 times, about 8 times, about 9 times, about 10 times, about 11 times, about 12 times, about 13 times, about 14 times, about 15 times, about 16 times, about 17 times, about 18 times or about 19 times, to about 0.2 times, about 0.5 times, about 0.7 times, about 1 time, about 1.5 times, about 2 times, about 3 times, about 4 times, about 5 times, about 6 times, about 7 times, about 8 times, about 9 times, about 10 times, about 11 times, about 12 times, about 13 times, about 14 times, about 15 times, about 16 times, about 17 times, about 18 times, about 19 times or about 20 times. In aspects, expansion of the silicate described herein contributes to the silicate's buoyancy. In typical aspects, the silicate is an expanded silicate. In addition, the silicate may function as an adsorption matrix for the larvicide component due to, for example, the presence of pores in its structure and/or its ion exchange capacity. In this way, the silicate described herein may function as a suitable carrier for the larvicide.

Typically, the silicate is a mineral, ionic compound, or non-ionic compound and, more typically, the silicate is a silicate mineral. In aspects, the silicate mineral is a nesosilicate, a sorocilicate, a cyclosilicate, an inosilicate, a phyllosilicate, a tectosilicate or combinations thereof. In aspects, the silicate mineral is a phyllosilicate. Examples of nesosilicates include, but are not limited to, andalusite, kyanite, sillimanite, dumortierite, topaz, staurolite, forsterite, fayalite, and tephroite. Examples of sorocilicates include, but are not limited to, hemimorphite (calamine), lawsonite, axinite, ilvaite, clinozoisite, allanite, and dollaseite. Examples of cyclosilicates include, but are not limited to, beryl, bazzite, sugilite, tourmaline, pezzottaite, osumilite, cordierite, and sekaninaite. Examples of inosilicates include, but are not limited to, jadeite, aegirine (or acmite), spodumene, pyroxferroite, diopside, hedenbergite, and augite. Examples of tectosilicates include, but are not limited to, microcline, orthoclase, anorthoclase, sanidine, nosean, cancrinite, leucite, nepheline, sodalite, and hauyne.

The phyllosilicate is typically a hydrous phyllosilicate and, more typically, the phyllosilicate is a clay mineral. Examples of such clay minerals include, but are not limited to, halloysite, kaolinite, illite, dickite, nacrite, nontronite, beidellite, smectite, montmorillonite, vermiculite, talc, sepiolite, palygorskite, pyrophyllite and combiantions thereof. In typical aspects, the silicate is vermiculite.

In typical aspects, the silicate is used in amounts of from about 5% to about 75% w/w based on the total weight of the composition, such as from about 5%, about 10%, about 15%, about 20%, about 25%, about 30%, about 35%, about 40%, about 45%, about 50%, about 55%, about 60%, about 65%, or about 70%, to about 10%, about 15%, about 20%, about 25%, about 30%, about 35%, about 40%, about 45%, about 50%, about 55%, about 60%, about 65%, about 70% or about 75% w/w. Typically, the silicate is used in an amount of about 32% w/w.

Additionally or alternatively, the buoyant article comprises a buoyant moiety. In aspects, the buoyant moiety comprises the silicate. In alternative or additional aspects, the buoyant moiety comprises the binder. In alternative or additional aspects, the buoyant moiety comprises any buoyant material. Typically, the buoyant moiety comprises a plant product and/or extract. For example, the buoyant moiety in aspects comprises an aquatic plant, such as a hydrophyte, and/or a corn cob or other floating plant part. In aspects, the buoyant moiety comprises dry plant material, such as a dry plant extract.

Any suitable larvicide is contemplated herein, many of which are known to the skilled person, such that the larvicide reduces or prevents the growth or development of, or kills aquatic pests. The larvicide may be broad-acting or specific for certain insect larvae, such as, for example mosquito larvae. In addition, the larvicide described herein is associated with the silicate, such that the silicate acts a carrier for the larvicide, both maintaining the larvicide in the article prior to use and allowing release of the larvicide over the surface of a body of water during use. The larvicide may be adsorbed onto the surface of the silicate (e.g. the larvicide may be directly (e.g. physically) attached to the silicate), and/or the larvicide may be held within the pores of the silicate through physical or non-physical attachment to the silicate, both of which may occur through, for example, van der Waals interactions, dipole-dipole interactions, induced dipole interactions, hydrogen bonding, covalent bonding, non-covalent bonding, coulombic forces and the like. Various and/or additional methods of association of the larvicide to the silicate would be understood by the skilled person.

Any suitable larvicides are contemplated for use herein. The larvicide is typically a microorganism, a chemical agent, a botanical oil, or combinations thereof. Examples of larvicidal chemical agents include, but are not limited to, S-Hydroprene, S-Kinoprene, Methoprene, S-Methoprene, organophosphates (e.g. temephos, echothiophate, diisopropyl fluorophosphate, tabun, tabun, sarin, soman, cyclosarin, diazinon, malathion, and parathion), chlorinated hydrocarbons, Abate®, Baytex®, Dursban®, resmethrin, malathion, pyrethrins, allethrin, Baygon®, Furadan®, methoxychlor, and the like; and petroleum or nonpetroleum film-forming oils such as Flit MLO®, GB-1111 or GB-1356, and Arosurf® MSF. The botanical oil is, for example, neem oil. In typical aspects, the larvicide is a microorganism such as, for example, Bacillus sphaericus (Bs), Bacillus thuringiensis (Bt), Bt fermentate, aquatic fungi, or combinations thereof. Other bacteria, protozoa, viruses, rickettsiae and nematodes are also contemplated as larvicides.

The articles described herein typically contain a Bacillus thuringiensis (Bt) fermentate, which comprises Bt, Bt spores, and one or more crystal proteins produced by the Bt, optionally in combination with a diluent, which is typically evaporated away during the process of forming the article described herein. The diluent used in the compositions described herein is typically water but could be any suitable solvent known to a skilled person. Typically, the diluent is water soluble and/or biodegradable and therefore can be applied to the liquid (e.g. water reservoirs) without harm to the environment, such as flora and fauna other than the targeted insects.

The article is typically non-toxic to humans and other animals or plants. As is known, Bt releases crystals that are toxic when mosquito larvae ingest them. The combination of an alkaline environment and the enzymes in the larvae midgut release the crystals' toxins, which cause cells to rupture in the larvae's gut, killing it in up to about 24 hours. Bt is safe for humans and other animals, because they lack the same combination of an alkali gut and the specific enzymes necessary. Moreover, Bt has the advantage that it degrades quickly and does not persist in the environment, so mosquitos are unlikely to build up a resistance to it.

The Bt used in the articles and methods described herein may be of any Bt subspecies that produces larvicidal crystal proteins. For example, the Bt subspecies may be selected from the group consisting of aizawai, alesti, berliner, cameroun, canadiensis, colmeri, coreanensis, dakota, darmstadiensis, dendrolimus, entomocidus, finitimus, fukuokaensis, galleriae, higo, Indiana, israelensis, japonensis, japonensis buibui, jegathesan, kenyae, kumamotoensis, kunthala, kurstaki, kyushuensis, medellin, mexcanensis, morrisoni, nigeriae, neoleonensis, ongbei, ostriniae, Pakistani, pondicheriensis, roskildiensis, san diego, shandogiensis, shanghai, silo, sotto, subtoxicus, tenebrionis, thompsoni, thuringiensis, tochigiensis, tohokuensis, tolworthi, toumanoffi, yunnanensis, wuhanensis, and combinations thereof. Typically, the Bt subspecies is selected from berliner, israelensis, kurstaki, tenebrionis, and combinations thereof. More typically, the Bt subspecies is Bacillus thuringiensis subsp. israelensis (Bti).

As is known, when Bt bacteria enter the stationary phase of growth, they begin to sporulate and produce crystal (or Cry) proteins. These are well known to a skilled person and it will be understood that any such crystal proteins may be included in the articles described herein. Typically the crystal proteins are not added separately to the article but are, rather, derived from the bacteria within the fermentate. It is contemplated, however, that the crystals could be used separately from the bacteria from which they are derived. In an aspect, additional exogenous crystal proteins not derived from the bacteria in the fermentate may be included in the articles described herein. In typical aspects, the Bt fermentate is derived from a culture that had been grown to stationary phase, such that the Bt began to sporulate and produce crystal proteins.

In typical aspects, the Bt fermentate is used in amounts of from about 0.01% to about 20% w/w based on the total weight of the composition, such as from about 0.05%, about 0.1%, about 0.2%, about 0.3%, about 0.4%, about 0.5%, about 0.6%, about 0.7%, about 0.8%, about 0.9%, about 1%, about 1.2%, about 1.5%, about 2%, about 2.5%, about 3%, about 3.5%, about 4%, or about 4.5% to about 0.1%, about 0.2%, about 0.3%, about 0.4%, about 0.5%, about 0.6%, about 0.7%, about 0.8%, about 0.9%, about 1%, about 1.2%, about 1.5%, about 2%, about 2.5%, about 3%, about 3.5%, about 4%, about 4.5%, or about 5% w/w. Typically, the Bt fermentate used has about 1.2% w/w of the active ingredient (Bti).

The silicate and the larvicide may be used in any suitable ratio which may be adjusted as desired depending on the specific silicate and larvicide chosen, such as for example, from about 1:200 to about 200:1, such as from about 1:150, about 1:100, about 1:75, about 1:50, about 1:25, about 1:20, about 1:15, about 1:10, about 1:9, about 1:8, about 1:7, about 1:6, about 1:5, about 1:4, about 1:3, about 1:2, or about 1:1 to about 2:1, about 3:1, about 4:1, about 5:1, about 6:1, about 7:1, about 8:1, about 9:1, about 10:1, about 15:1, about 20:1, about 25:1, about 50:1, about 75:1, about 100:1, about 150:1, or about 200:1. In typical aspects, the ratio is about 1:2.

In addition, the silicate and larvicide may be used in amounts of from about 1% to 99% w/v, such as for example, about 1%, about 5%, about 10%, about 20%, about 30%, about 40%, about 50%, about 60%, about 70%, about 80%, about 90%, or about 95%, to about 5%, about 10%, about 20%, about 30%, about 40%, about 50%, about 60%, about 70%, about 80%, about 90%, about 95% or about 99% w/v. Typically, the silicate to larvicide is used in about 50% w/v.

The binder is used in the articles described herein in order to agglomerate the larvicide-associated silicate particles into a formed article. In typical aspects, the binder is buoyant. In this way, the binder may assist in the buoyancy of the article when the article is put in the liquid. In alternate or additional aspects, the binder is biodegradable and environmentally friendly. In aspects where both the binder and the silicate are buoyant, these components typically act synergistically to enhance the extent of buoyancy and/or the time of buoyancy of the resulting agglomerated article. For example, when the binder described herein dries, the density thereof will tend to decrease such that the density of binder, on its own, is typically less than a liquid medium (e.g. water). When, for example, the silicate described herein is in the form of, for example, expanded fragments that are combined into the article described herein (such as, in the form of a block of silicate fragments bound by the binder described herein), the article tends to have improved buoyancy (e.g. longer float times) in the form of the bound up block, as opposed to when the silicate fragments are not bound by the binder. In aspects, the non-bound silicate fragments may be buoyant in the liquid for, for example, about 15 hours to about 45 hours, such as for example, about 24 hours to about 36 hours, whereas, the bound silicate fragments may be buoyant for about 2 days to about 10 days, such as for about 2 days, about 3 days, about 4 days, about 5 days, about 6 days, about 7 days, about 8 days or about 9 days, to about 3 days, about 4 days, about 5 days, about 6 days, about 7 days, about 8 days, about 9 days or about 10 days. In typical aspects, the binder agglomerated silicate article described herein is buoyant for about 6 days.

It will be understood that the binder can be any component capable of agglomerating and/or compacting the silicate into a formed article. In typical aspects, the binder comprises a polymer, such as for example, a cross-linked polymer or a linear polymer, or a combination thereof. In other aspects, the polymer comprises a viscoelastic polymer (e.g. the polymer may act as a type of non-Newtonian fluid with viscous (liquid) properties and elastic (solid) properties). In aspects, the binder is a polymer comprising polyvinyl alcohol and in other aspects, the binder is a polymer comprising a borate ion. In other aspects, the polymer comprises polyvinyl alcohol and the borate ion, such that the binder comprises the components of “slime”, made by mixing glue with a source of borate ions. In other aspects, the polymer comprises a silicone polymer selected the group consisting of siloxane gums, silicone elastomers, polysiloxanes, crosslinked siloxane polymers and combinations thereof. In other aspects, the polymer comprises a polysaccharide. Examples of polysaccharides include, but are not limited to, galactomannan, starch, guar gum and combinations thereof. When starch is used as the polysaccharide based polymer, the starch is derived from, for example, corn, wheat, potato, cassava, yam, peas or lentils. Typically, the binder is capable of maintaining a desired shape of the formed article, upon mixing the article components and drying or otherwise curing the article.

In typical aspects, the binder is used in amounts of from about 5% to about 95% w/w based on the total weight of the composition, such as from about 5%, about 10%, about 15%, about 20%, about 25%, about 30%, about 35%, about 40%, about 45%, about 50%, about 55%, about 60%, about 65%, about 70%, about 75%, about 80%, about 85%, or about 90%, to about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% w/w.

The binder and larvicide/silicate may be used in any suitable ratio, such as for example, such as from about 1:200 to about 200:1, such as from about 1:150, about 1:100, about 1:75, about 1:50, about 1:25, about 1:20, about 1:15, about 1:10, about 1:9, about 1:8, about 1:7, about 1:6, about 1:5, about 1:4, about 1:3, about 1:2, or about 1:1 to about 2:1, about 3:1, about 4:1, about 5:1, about 6:1, about 7:1, about 8:1, about 9:1, about 10:1, about 15:1, about 20:1, about 25:1, about 50:1, about 75:1, about 100:1, about 150:1, or about 200:1. Typically, the larvicide/silicate and the binder are used in a ratio of about 1:1.5.

It would be understood that the amount of the binder may be controlled, such that the amount of the binder used may impact, for example, the degree of compactness of the article described herein, control the rate of release of the larvicide described herein and/or the time or extent of buoyancy of the formed article. For example, higher ratios of binder to larvicide/silicate, or increased amounts of binder employed in the article described herein, may result in a less compact article (e.g. increased space between the silicate particles) and/or may increase the buoyancy of the article based on the increased amounts of buoyant binder found in the article. These factors may or may not influence the release of the larvicide described herein.

The articles described herein may be in any suitable form, but are typically in the form of a dried, ready to use, unit dose form. The article described herein may also take on a variety of shapes, such as, for example, a substantially round shape, a donut shape, or a sheet-like shape that is optionally sectionable into a plurality of unit dose forms. In this way, the article is dosed appropriately for a specific amount of liquid to which the article is to be placed (or the article may be produced as a series of unit dose forms that are partitionable from a larger unit dose form). For example, the unit dose form can be dosed based a specific surface area of liquid and/or a specific volume of liquid. In this way, the unit dose form has an amount of the larvicide that is effective for use on the surface area of the liquid and/or the volume of the liquid. In other aspects, the unit dose form has an amount of the larvicide that is effective for use on the surface area of the liquid. In still other aspects, the unit dose form has an amount of the larvicide that is not based on the volume of the liquid. Basing the dosage of the larvicide on the surface area of the liquid provides an advantage as a user may be able to more readily determine the amount of the article (e.g. in the form of a unit dose) required for the liquid, since the depth of the liquid, which would be not be easily obtainable by visual inspection alone, is not required. In other words, the surface area of a body water can be estimated easily upon visual inspection and simple measurements. Estimating the volume of the body of water is more challenging. Accordingly, in aspects, the unit dose forms described herein provide an efficient method of using the correct amount of the larvicide described herein for a body of water of unknown volume.

In typical embodiments, the article described herein is disintegrable in the liquid when placed therein. In this way, the binder works to agglomerate (e.g. hold) the silicate together, such that when the article described herein is placed in the liquid, the article can disintegrate over time dispersing the larvicide over a surface of the liquid. Thus, while the article described herein is floating on the liquid, the larvicide may be slowly released at the liquid's surface and can therefore be ingested by, for example, mosquito larvae growing there. In aspects, the larvicide described herein may be released at the surface of the liquid by, for example, leaching by the liquid, the gradual dissociation of the article described herein into the liquid, or a combination thereof.

In aspects, the dispersion of the larvicide over the surface of the liquid allows for greater than about 50% of the larvicide present in the article described herein to remain at the surface of the liquid for greater than about 24 hours. For example, greater than about 50%, about 60%, about 70%, about 80%, about 90%, about 95%, about 97%, about 98% or about 99% of the larvicide remains at the surface of the liquid for greater than about 24, about 48, about 72, about 96, about 120, about 144 or about 168 hours. In other aspects, the article described herein remains buoyant for about 24 hours to about 168 hours, such as for example, from about 24 hours, about 30 hours, about 40 hours, about 50 hours, about 60 hours, about 70 hours, about 80 hours, about 90 hours, about 95 hours, about 100 hours, about 120 hours, about 140 hours, about 150 hours, or about 160 hours, to about 30 hours, about 40 hours, about 50 hours, about 60 hours, about 70 hours, about 80 hours, about 90 hours, about 95 hours, about 100 hours, about 120 hours, about 144 hours, about 150 hours, about 160 hours or about 168 hours. In aspects, the buoyancy of the article is directly related to the synergistic effect of the binder and the silicate, having buoyant properties themselves, as described herein.

In other typical aspects, the article described herein has a specific gravity of less than about one, such about less than 1, less than about 0.95, less than about 0.9, less than about 0.85, or less than about 0.8. In this way, the article described herein is capable of providing a controlled dispersion of the larvicide described herein through the ability of the article described herein to float on the surface of the liquid when placed in, such as, for example, a reservoir, catch basin, potable water storage tank, a pond, a lake, a swamp, a marsh, or a culvert. In typical aspects, the liquid is a slow-moving or stagnant liquid which may be a preferred liquid for female mosquitos laying their eggs as well as for the growth and development of the larvae that are produced therefrom.

### Methods of Making the Buoyant Article

Methods of making the buoyant article described herein are provided. In general, the method comprises associating a silicate with a larvicide, and agglomerating the silicate with a binder.

The articles described herein, in aspects, are prepared by culturing the Bt under conditions that promote entering of stationary phase, such that the bacteria will begin to sporulate and produce Cry proteins. For example, the Bt are typically cultured at about 30° C., with agitation of about 200 rpm, and at a pH of about 7.0. When nutrients become scarce, the cells begin to sporulate into the fermentate.

In aspects, the larvicide (e.g. the Bt fermentate described above) is then associated with (e.g. adsorbed onto and/or into) the silicate. In typical aspects, the silicate described herein is expanded, typically using heating, prior to the associating step. For example, the silicate may be expanded by heating the silicate to about 500° C. to about 1000° C., such as for example, from about 500° C., about 600° C., about 700° C., about 800° C., or about 900° C., to about 600° C., about 700° C., about 800° C., or about 900° C. or about 1000° C. Typically, the silicate is expanded by heating the silicate to greater than about 870° C. In typical aspects, the silicate is vermiculite. When heated in this manner, the silicate (e.g. vermiculite) can increase in volume (e.g. about 0.5 times to 20 times increase in volume as described herein) such that the density of the silicate decreases to facilitate the buoyancy of the silicate. In this way, when expanded, the silicate becomes lightweight which can improve the buoyancy of the silicate and the silicate may be have increased adsorbency of the larvicide described herein onto and/or into the expanded silicate.

In typical aspects, the resultant fermentate is mixed with the expanded silicate described herein and a lower alkyl alcohol, such as, for example, ethylene glycol, propylene glycol, or glycerol. Typically, the lower alkyl alcohol is glycerol. The lower alkyl alcohol may be useful to facilitate, for example, adsorption of the larvicide onto and/or into the expanded silicate. In typical aspects, the expanded silicate, the lower alkyl alcohol and the fermentate are mixed until forming, for example, a paste. In typical aspects, the paste is a homogenous paste. In other aspects, the paste can be a non-homogenous paste. It would be understood that the homogeneity of the paste will, in aspects, depend on the mixing time. Following this, in typical aspects, the resulting paste may be placed in an incubator to facilitate drying of the resulting paste. For example, the resulting paste may be dried at about 37° C. for about 3 days, such as for example, about 36° C., about 37° C., about 38° C. or about 39° C., for about 2 days, about 3 days, about 4 days or about 5 days.

After the drying step described above, the resulting dried paste is typically mixed with the binder described herein. In order to produce a solution of the binder for agglomerating the components of the article, the polymer described herein, such as for example, polyvinyl alcohol is mixed with a solution comprising borate ions. For example, the solution comprising borate ions may comprise sodium bicarbonate solution and boric acid. In typical aspects, the polymer and borate ion solution is mixed until a mass is produced. In typical aspects, the mass is a homogenous mass. In other aspects, the mass is a non-homogenous mass. It is understood that the homogeneity of the mass may depend on, for example, the mixing time.

Following the mixing step, the resulting mass can be added to the resulting dried paste and molded into the unit dose form described herein as desired. In typical aspects, the unit dose forms may be placed in the incubator, at a temperature of about 37° C. for about 3 days to about 5 days in order to facilitate drying of the unit dose form. For example, the unit dose form may be dried at about 36° C., about 37° C., about 38° C. or about 39° C., for about 2 days, about 3 days, about 4 days, about 5 days, about 6 days or about 7 days. It is understood that type of incubator used in the drying step can influence the drying time, such that, for example, if an air forced dry incubator is used, the time to dry the unit dose form can be reduced.

### Methods of Use of the Buoyant Article

The article described herein can be used for a variety applications, including treating a liquid having an unknown volume or reducing mosquito populations and/or reducing the spread of mosquito-borne diseases. In typical aspects, the liquid is a slow-moving or stagnant liquid. Examples of liquids suitable for application of the article described herein include, but are not limited to, a reservoir, catch basin, potable water storage tank, a pond, a lake, a swamp, a marsh, or a culvert. In aspects, the articles described herein can also be used for pre-flood treatment. If the articles are applied to dry areas which are known or suspected to become breeding sites when flooded, such as, for example, woodland pools and abandoned swimming pools, the articles may float to the surface when flooding occurs and start releasing the larvicide described herein. In typical aspects, alternate wetting and drying cycles may not reduce the effectiveness of the article described herein. In this way, the article described herein may be placed on the ground, in anticipation of a rainfall, such that as the rain fills the area, the article may be activated to disintegrate allowing for dispersion of the larvicide, as described herein. As described herein, as long as the surface area is estimated or calculated, the user can use the appropriate amount of larvicide (e.g. according to the unit dose form calculated for the specific surface area coverage) and leave the article on the dry ground until the next rainfall. Alternatively, the unit dose form could be sectioned appropriately (e.g. if less than the amount of larvicide contained in the article is required based on the surface area of the dry area) and left in the dry area.

In typical aspects, the article described herein may be used to treat about 10 square feet of surface liquid for up about 14 days. For example, the articles described herein may be used to treat about 6, about 7, about 8, about 9, about 10, about 11, or about 12 square feet of surface liquid, for up to about 12 days, about 13 days, about 14 days, about 15 days or about 16 days. Advantageously, if less liquid is required to be treated (based on the dosage of the unit dose form of the article described herein), the article may be broken up into smaller sections to accommodate the smaller surface area calculation. On the other hand, if more liquid is required to be treated, a plurality of articles may be used to treat the area, as appropriate. This may reduce waste of the article described herein and/or over saturation of the liquid with the larvicide since the appropriate amount of larvicide may be tailored for the appropriate amount of water (based on the surface area thereof). Moreover, the articles described herein are, typically, position “neutral” or insensitive, such that, the user may just throw the article described herein into the liquid without regard to, for example, the orientation of the article (e.g. whether the article lands on a “top” or a “bottom” side of the article), or whether or not the liquid is substantially stagnant or the liquid is somewhat turbulent, the latter of which may cause the article described herein to flip over. In typical aspects, regardless of the orientation of the article described herein, the larvicide present in the article is dispersed over the surface of the water such that aqueous pests like mosquito larvae are effectively killed.

In typical aspects, using the article involves placing the article described herein in the liquid and allowing it to disintegrate over time such that the larvicide described herein may be dispersed at the surface of the liquid. As described herein, the larvicide present in the article described herein typically remains at the surface of the liquid for greater than 24 hours. In this way, the article described herein, when in contact with, for example, infested water, may release the larvicide described herein slowly into the water at the water surface such that the larvicide is capable of maintaining a toxic concentration to larvae for a period of days to weeks in stagnant water. Thus, the article described herein may allow for the larvicide to be in the immediate larval environment for efficient and effective killing of, for example, mosquito larvae at the water surface.

The articles described herein are useful against any insect susceptible to, for example, Bt larvicidal activity. For example, the articles described herein find particular use in killing Aedes, Culex, Anopheles, Mansonia, and/or Simulium larvae. Typical targets include mosquitos that carry disease, such as those that carry malaria, dengue, West Nile virus, chikungunya, yellow fever, filariasis, Japanese encephalitis, Saint Louis encephalitis, Western equine encephalitis, Eastern equine encephalitis, Venezuelan equine encephalitis, La Crosse encephalitis, and/or Zika. Aedes aegypti, Culex quiquefaciatus, and Simulium spp. are typical targeted species. The articles described herein are also useful for domestic use to reduce mosquito larvae outbreaks. The articles described herein may be reapplied to the liquid as needed, or may be used daily, weekly, or monthly and/or after each rainfall. Moreover, since it is in a ready to use unit dose form, there is no need for any further manipulation on the part of the user, but the user is only required to throw the article into the liquid and allow the article to disintegrate thereby allowing the larvicide to accumulate at the liquid's surface and prevent larvae that may be present in the liquid from developing into adulthood and spreading disease.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1. Preparation of the Buoyant Article

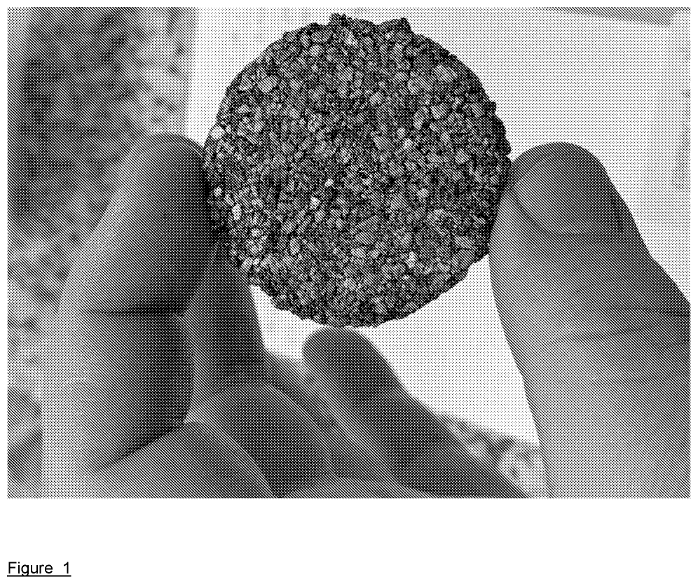

The buoyant article of the present invention, such as that which is shown in FIG. 1, was made by the following method.

To prepare the tablet base, about 500 grams of expanded vermiculite was weighed and about 1000 ml of Bacillus thuringiensis subsp israelensis fermentate and about 50 ml of glycerin were measured. The three items were added in a container and mixed until a homogeneous paste was formed. Afterwards, the prepared base was placed in an incubator at about 37° C. for about 3 days and dried.

To prepare the tablet, about 720 grams of the dry paste, plus about 480 grams of polyvinyl alcohol (PVA) solution, were weighed. Immediately thereafter, about 38 ml of sodium bicarbonate solution with boric acid (boric acid at about 3% plus sodium bicarbonate (about 20 grams to about 100 ml of boric acid solution)) was added. In particular, slime was made by mixing PVA glue with borate ions. The formed slime was then used to agglomerate the vermiculite/Bti. The components were mixed well until the mixture formed a homogeneous mass. Afterwards, about 12 grams per tablet was weighed and molded into the established format. The formed tablets were placed in an incubator 37° C. for about 3 to about 5 days and dried.

When the prepared agglomerated article was compared to one that was not agglomerated with a binder, it was found that the agglomerated article floated for about 7 days before the vermiculite fragments dispersed and submerged in the water, whereas a non-binder containing article did not form a solid article.

The above disclosure generally describes the present invention. Although specific terms have been employed herein, such terms are intended in a descriptive sense and not for purposes of limitation.

Patent applications, patents, and publications are cited herein to assist in understanding the embodiments described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

Although specific embodiments of the invention have been described herein in detail, it will be understood by those skilled in the art that variations may be made thereto without departing from the spirit of the invention or the scope of the appended claims.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

We claim:

1. A buoyant larvicidal article comprising:
a silicate;
a larvicide associated with the silicate; and
a binder for agglomerating the silicate.

2. The article of claim 1, wherein the silicate is buoyant.

3. The article of claim 1 or 2, wherein the silicate is expandable.

4. The article of any one of claims 1 to 3, wherein the silicate is a hydrous silicate.

5. The article of any one of claims 1 to 4, wherein the silicate is expandable to a volume of about 0.5 times to about 20 times an original volume of the silicate.

6. The article of any one of claims 1 to 5, wherein the silicate is used in an amount of about 5% w/w to about 75% w/w.

7. The article of claim 6, wherein the silicate is used in an amount of about 32% w/w.

8. The article of any one of claims 1 to 7, wherein the silicate comprises a silicate mineral.

9. The article of claim 8, wherein the silicate mineral is selected from the group consisting of nesosilicates, sorocilicates, cyclosilicates, inosilicates, phyllosilicates, tectosilicates and combinations thereof.

10. The article of any one of claims 1 to 9, wherein the silicate mineral comprises a phyllosilicate.

11. The article of claim 10, wherein the phyllosilicate comprises a clay mineral.

12. The article of claim 11, wherein the clay mineral is selected from the group consisting of halloysite, kaolinite, illite, dickite, nacrite, nontronite, beidellite, smectite, montmorillonite, vermiculite, talc, sepiolite, palygorskite, pyrophyllite and combinations thereof.

13. The article of claim 12, wherein the clay mineral comprises vermiculite.

14. The article of any one of claims 1 to 13, wherein the larvicide is selected from the group consisting of a microorganism, a chemical agent, a botanical oil, and combinations thereof.

15. The article of any one of claims 1 to 14, wherein the larvicide is used in an amount of about 0.01% to about 20% w/w.

16. The article of claim 15, wherein the larvicide is used in an amount of about 1.2% w/w.

17. The article of claim 14, wherein the microorganism is selected from Bacillus sphaericus (Bs), Bacillus thuringiensis (Bt), Bt fermentate, aquatic fungi and combinations thereof.

18. The article of claim 17, wherein the Bacillus thuringiensis (Bt) subspecies is selected from the group consisting of aizawai, alesti, berliner, cameroun, canadiensis, colmeri, coreanensis, dakota, darmstadiensis, dendrolimus, entomocidus, finitimus, fukuokaensis, galleriae, higo, Indiana, israelensis, japonensis, japonensis buibui, jegathesan, kenyae, kumamotoensis, kunthala, kurstaki, kyushuensis, medellin, mexcanensis, morrisoni, nigeriae, neoleonensis, ongbei, ostriniae, Pakistani, pondicheriensis, roskildiensis, san diego, shandogiensis, shanghai, silo, sotto, subtoxicus, tenebrionis, thompsoni, thuringiensis, tochigiensis, tohokuensis, tolworthi, toumanoffi, yunnanensis, wuhanensis, and combinations thereof.

19. The article of claim 18, wherein the Bt subspecies comprises israelensis.

20. The article of any one of claims 14 to 19, wherein the chemical agent is selected from the group consisting of S-Hydroprene, S-Kinoprene, Methoprene, S-Methoprene, organophosphates, chlorinated hydrocarbons and combinations thereof.

21. The article of claim 20, wherein the organophosphate is selected from the group consisting of temephos, echothiophate, diisopropyl fluorophosphate, tabun, tabun, sarin, soman, cyclosarin, diazinon, malathion, parathion and combinations thereof.

22. The article of any one of claims 14 to 21, wherein the botanical oil is neem oil.

23. The article of any one of claims 1 to 22, wherein the binder is buoyant.

24. The article of any one of claims 1 to 23, wherein the binder is biodegradable.

25. The article of any one of claims 1 to 24, wherein the binder is used in an amount of about 5% to about 95% w/w.

26. The article of any one of claims 1 to 25, wherein the binder and the silicate act synergistically to provide buoyancy to the article.

27. The article of any one of claims 1 to 26, wherein the binder comprises a polymer.

28. The article of claim 27, wherein the polymer comprises a cross-linked polymer or a linear polymer.

29. The article of claim 27 or 28, wherein the polymer comprises a viscoelastic polymer.

30. The article of any one of claims 27 to 29, wherein the polymer comprises polyvinyl alcohol.

31. The article of any one of claims 27 to 30, wherein the polymer comprises a borate ion.

32. The article of any one of claims 27 to 29, wherein the polymer comprises polyvinyl alcohol and a borate ion.

33. The article of any one of claims 27 to 32, wherein the polymer comprises a silicone polymer.

34. The article of claim 33, wherein the silicone polymer is selected from the group consisting of siloxane gums, silicone elastomers, polysiloxanes, crosslinked siloxane polymers and combinations thereof.

35. The article of any one of claims 27 to 34, wherein the polymer comprises a polysaccharide selected from the group consisting of galactomannan, guar gum, starch and combinations thereof.

36. The article of claim 35, wherein the starch is derived from corn, wheat, potato, cassava, yam, peas or lentils.

37. The article of any one of claims 1 to 36, wherein the binder is not a sulfate mineral.

38. The article of claim 37, wherein the binder is not gypsum.

39. The article of any one of claims 1 to 38, wherein the binder comprises slime.

40. The article of any one of claims 1 to 39, wherein the article is a unit dose form.

41. The article of claim 40, wherein the unit dose form is ready to use.

42. The article of claim 40 or 41, wherein the unit dose form is a dried solid.

43. The article of any one of claims 40 to 42, wherein the unit dose form has an amount of the larvicide that is based on surface area of a liquid and/or volume of the liquid.

44. The article of any one of claims 40 to 42, wherein the unit dose form has an amount of the larvicide that is based on surface area of a liquid.

45. The article of any one of claims 40 to 42, wherein the unit dose form has an amount of the larvicide that is not based on volume of a liquid.

46. The article of any one of claims 1 to 45, wherein the article, when placed in a liquid, disintegrates over time dispersing the larvicide over a surface of the liquid.

47. The article of 46, wherein greater than 50% of the larvicide present in the article remains at the surface of the liquid for greater than 24 hours.

48. The article of claim 46, wherein greater than 60% of the larvicide present in the article remains at the surface of the liquid for greater than 24 hours.

49. The article of claim 46, wherein greater than 70% of the larvicide present in the article remains at the surface of the liquid for greater than 24 hours.

50. The article of claim 46, wherein greater than 80% of the larvicide present in the article remains at the surface of the liquid for greater than 24 hours.

51. The article of claim 46, wherein greater than 90% of the larvicide present in the article remains at the surface of the liquid for greater than 24 hours.

52. The article of any one of claims 1 to 51, wherein the article remains buoyant for about 24 hours to about 168 hours.

53. The article of any one of claims 43 to 52, wherein the liquid is a slow-moving or stagnant liquid.

54. The article of claim 53, wherein the liquid is a reservoir, catch basin, potable water storage tank, a pond, a lake, a swamp, a marsh, or a culvert.

55. The article of any one of claims 1 to 54, wherein the article has a specific gravity of less than about one.

56. The article of any one of claims 1 to 55, wherein the article has a substantially round shape.

57. The article of any one of claims 1 to 55, wherein the article has a sheet-like shape that is sectionable into a plurality of unit dose forms.

58. A buoyant larvicidal article comprising:
a buoyant moiety;
a larvicide associated with the buoyant moiety; and
a binder for agglomerating the buoyant moiety.

59. The article of claim 58, wherein the buoyant moiety comprises an aquatic plant or part thereof.

60. The article of claim 58 or 59, wherein the buoyant moiety comprises a corn cob or part thereof and/or wherein the buoyant moiety comprises dry plant material.

61. The article of any one of claims 58 to 60, further comprising a silicate.

62. A method of reducing mosquito populations and/or reducing the spread of mosquito-borne disease, the method comprising placing the article as defined in any one of claims 1 to 61 in the liquid.

63. A method of treating a liquid having an unknown volume, comprising placing the article as defined in any one of claims 1 to 61 in the liquid.

64. The method of claim 62 or 63, further comprising allowing the article as defined in any one of claims 1 to 45 to disintegrate over time.

65. The method of any one of claims 62 to 64, further comprising allowing the larvicide to remain at a surface of the liquid for greater than 24 hours.

66. A method of making a buoyant article, the method comprising
associating a silicate with a larvicide; and
agglomerating the silicate with a binder.
